(19) United States
(12) Patent Application Publication
(10) Pub. No.: US 2022/0204153 A1
(43) Pub. Date: Jun. 30, 2022

(54) SYSTEM AND METHOD FOR LOADING AND SECURING PAYLOAD IN AN AIRCRAFT

(71) Applicant: BETA AIR, LLC, South Burlington, VT (US)

(72) Inventors: Riley Griffin, Montpelier, VT (US); Morgan Wyeth Gomez, Richmond, VT (US); Kyle B. Clark, Underhill, VT (US); James Laughlin, Burlington, VT (US); Andrew Thomas Bernard, Cary, NC (US); Clint Shook, Pleasant, SC (US)

(73) Assignee: BETA AIR, LLC, South Burlington, VT (US)

(21) Appl. No.: 17/137,594

(22) Filed: Dec. 30, 2020

(51) Int. Cl. B64C 1/22; B64D 9/00

(52) U.S. Cl. CPC B64C 1/22; B64C 29/0016; B64D 2009/006; B64D 9/003

(57) ABSTRACT

In an aspect a system for loading and securing a payload in an electrical vertical take-off and landing (eVTOL) aircraft may comprise a fuselage further comprising structural elements configured to provide physical support for the aircraft fuselage. An eVTOL aircraft may also comprise a swing nose, where a portion of the nose of the aircraft may swing on a hinge in a radial direction orthogonal to the longitudinal axis of the aircraft. The hinge may be coupled to at least a portion of the fuselage and at least a portion of the nose of the aircraft. A latching mechanism may be configured to secure a payload in an aircraft fuselage. A conveyor mechanism may be configured to transport a payload into the fuselage from the opening of the aircraft.

### FIELD OF INVENTION

The present invention generally relates to the field of aircraft and aircraft components. In particular, the present invention is directed to a system and method for loading and securing a payload in an electric aircraft for transportation.

### BACKGROUND

The burgeoning of electric vertical take-off and landing (eVTOL) aircraft technologies promises an unprecedented forward leap in energy efficiency, cost savings, and the potential of future autonomous and unmanned aircraft. However, the technology of eVTOL aircraft is still lacking in crucial areas of payload transportation systems. This is particularly problematic as it compounds the already daunting challenges to designers and manufacturers developing the aircraft for manned and/or unmanned flight in the real world. Current cargo transport is most often accomplished through couriers, motor vehicles, vans, box trucks, tractor trailers, freight trains, cargo ships of various sizes, and various commercial and military aircraft, among others. Current passenger transport can and is accomplished in myriad ways one of ordinary skill in the art would understand to include, bicycles, motorcycles, motor vehicles, trucks, airplanes, helicopters, and trains, among many others. The ability of an eVTOL aircraft to transport goods, people, or a combination thereof may provide new business, emergency, and civilian applications.

### SUMMARY OF DISCLOSURE

In an aspect a system for loading and securing a payload in an electrical vertical take-off and landing (eVTOL) aircraft may comprise a fuselage further comprising structural elements configured to provide physical support for the aircraft fuselage. An eVTOL aircraft may also comprise a swing nose, where a portion of the nose of the aircraft may swing on a hinge in a radial direction orthogonal to the longitudinal axis of the aircraft. The hinge may be coupled to at least a portion of the fuselage and at least a portion of the nose of the aircraft. A latching mechanism may be configured to secure a payload in an aircraft fuselage. A conveyor mechanism may be configured to transport a payload into the fuselage from the opening of the aircraft.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an isometric view illustrating an eVTOL aircraft, according to an example embodiment;

FIG. 2 is an isometric view illustrating an exemplary fuselage, including structural elements;

FIGS. 3A-B are isometric views illustrating exemplary swing nose configurations of an eVTOL aircraft including fuselages;

FIG. 4A-B are isometric views illustrating exemplary payload securement mechanisms and components thereof;

FIG. 5A-B are isometric views illustrating exemplary payload conveyor mechanisms;

FIG. 6 is a block diagram illustrating an exemplary embodiment of a computer system.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

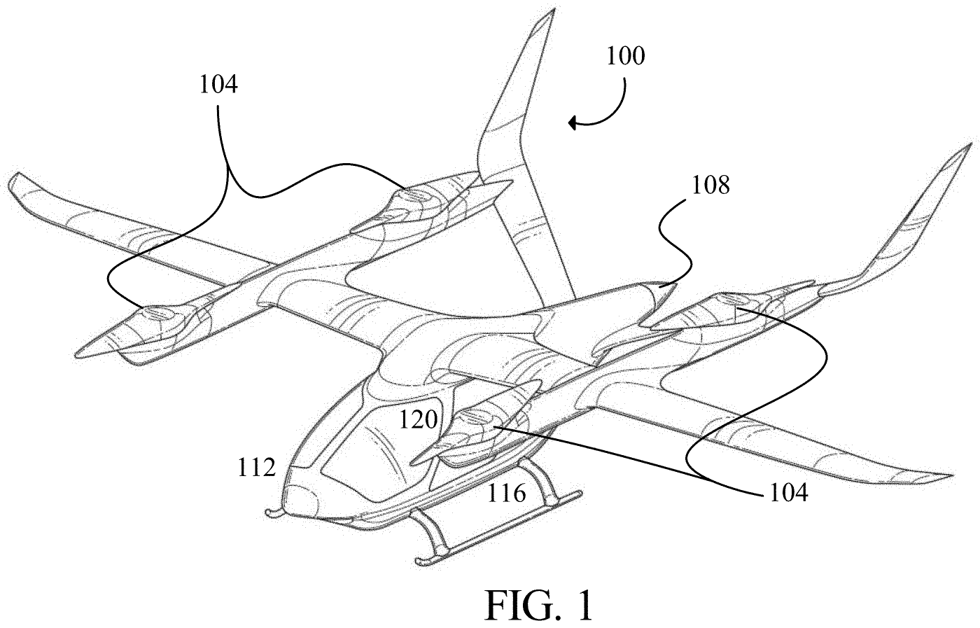

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply embodiments of the inventive concepts defined in the appended claims. Hence, specific dimensions and other physical characteristics relating to the embodiments disclosed herein are not to be considered as limiting, unless the claims expressly state otherwise.

Referring now to FIG. 1, an isometric view of dual-mode aircraft 100 is presented. Dual-mode aircraft 100 can comprise an autonomous aircraft, a vertical take-off and landing aircraft, an electric take-off and landing aircraft, a quadcopter, a tilt-rotor aircraft, a fixed wing aircraft, a captured lift fan aircraft, a hovercraft, a combination thereof, or another aircraft not listed herein.

Dual-mode aircraft 100 may comprise a propulsor. A propulsor may include a motor. A motor may include without limitation, any electric motor, where an electric motor is a device that converts electrical energy into mechanical energy, for instance by causing a shaft to rotate. A motor may be driven by direct current (DC) electric power; for instance, a motor may include a brushed DC motor or the like. A motor may be driven by electric power having varying or reversing voltage levels, such as alternating current (AC) power as produced by an alternating current generator and/or inverter, or otherwise varying power, such as produced by a switching power source. A motor may include, without limitation, a brushless DC electric motor, a permanent magnet synchronous motor, a switched reluctance motor, and/or an induction motor; persons skilled in the art, upon reviewing the entirety of this disclosure, will be aware of various alternative or additional forms and/or configurations that a motor may take or exemplify as consistent with this disclosure. In addition to inverter and/or switching power source, a circuit driving motor may include electronic speed controllers (not shown) or other components for regulating motor speed, rotation direction, torque, and/or dynamic braking. Motor may include or be connected to one or more sensors detecting one or more conditions of motor; one or more conditions may include, without limitation, voltage levels, electromotive force, current levels, temperature, current speed of rotation, position sensors, and the like. For instance, and without limitation, one or more sensors may be used to detect back-EMF, or to detect parameters used to determine back-EMF, as described in further detail below. One or more sensors may include a plurality of current sensors, voltage sensors, and speed or position feedback sensors. One or more sensors may communicate a current status of motor to a person operating system or a computing device; computing device may include any computing device as described below, including without limitation, a vehicle controller.

Computing device may use sensor feedback to calculate performance parameters of motor, including without limitation a torque versus speed operation envelope. Persons skilled in the art, upon reviewing the entirety of this disclosure, will be aware of various devices and/or components that may be used as or included in a motor or a circuit operating a motor, as used and described herein. In an embodiment, propulsors may receive differential power consumption commands, such as a propeller or the like receiving command to generate greater power output owing a greater needed contribution to attitude control, or a wheel receiving a greater power output due to worse traction than another wheel under slippery conditions.

A motor may be connected to a thrust element. Thrust element may include any device or component that converts the mechanical energy of the motor, for instance in the form of rotational motion of a shaft, into thrust in a fluid medium. Thrust element may include, without limitation, a device using moving or rotating foils, including without limitation one or more rotors, an airscrew or propeller, a set of airscrews or propellers such as contra-rotating propellers or co-rotating propellers, a moving or flapping wing, or the like. Thrust element may include without limitation a marine propeller or screw, an impeller, a turbine, a pump-jet, a paddle or paddle-based device, or the like. Thrust element may include a rotor. Persons skilled in the art, upon reviewing the entirety of this disclosure, will be aware of various devices that may be used as thrust element.

With continued reference to FIG. 1, and in embodiments, dual-mode aircraft 100 may include vertical propulsor 104 and forward propulsor 108. Forward propulsor 108 can comprise a propulsor configured to propel dual-mode aircraft 100 in a forward direction. Forward in this context is not an indication of the propulsor position on aircraft 100. In embodiments, one or more forward propulsors 108 can be mounted on the front, on the wings, at the rear, etc. of dual-mode aircraft 100. Vertical propulsor 104 can comprise a propulsor configured to propel the aircraft in an upward direction. One of ordinary skill in the art would understand upward to comprise the imaginary axis protruding from the earth at a normal angle, configured to be normal to any tangent plane to a point on a sphere (i.e. skyward). In embodiments, vertical propulsor 104 may be mounted on the front, on the wings, at the rear, and/or any suitable location of aircraft 100. A “propulsor”, as used herein, is a component or device used to propel a craft by exerting force on a fluid medium, which may include a gaseous medium such as air or a liquid medium such as water. In an embodiment, vertical propulsor 104 can be a propulsor that generates a substantially downward thrust, tending to propel an aircraft in an opposite, vertical direction and provides thrust for maneuvers. Such maneuvers can include, without limitation, vertical take-off, vertical landing, hovering, and/or rotor-based flight such as “quadcopter” or similar styles of flight. According to embodiments, forward propulsor 108 can comprise a propulsor positioned for propelling an aircraft in a “forward” direction. Here, forward propulsor 108 may include one or more propulsors mounted on the front, on the wings, at the rear, or a combination of any such positions. Forward propulsor can be configured to propel aircraft 100 forward for fixed-wing and/or “airplane”-style flight, takeoff and/or landing, and/or may propel the aircraft forward or backward on the ground.

In embodiments, vertical propulsor 104 and forward propulsor 108 may also each include a thrust element. A thrust element may include any device or component that converts mechanical energy of a motor, for instance in the form of rotational motion of a shaft, into thrust within a fluid medium. A thrust element may include, without limitation, a device using moving or rotating foils, including without limitation one or more rotors, an airscrew or propeller, a set of airscrews or propellers such as contra-rotating propellers, a moving or flapping wing, or the like. A thrust element may include without limitation a marine propeller or screw, an impeller, a turbine, a pump-jet, a paddle or paddle-based device, or the like. As another non-limiting example, a thrust element may include an eight-bladed pusher propeller, such as an eight-bladed propeller mounted behind the engine to ensure the drive shaft is in compression. Persons skilled in the art, upon reviewing the entirety of this disclosure, will be aware of various devices that may be used as a thrust element.

According to embodiments, vertical propulsor 104 and forward propulsor 108 may also include a motor mechanically coupled to a respective propulsor as a source of thrust. Said motor may include, without limitation, any electric motor that comprises a device to convert electrical energy into mechanical energy, such as, for instance, by causing a shaft to rotate. A motor may be driven by direct current (DC) electric power—for instance, a motor may include a brushed DC a motor, or the like. In embodiments, a motor may be driven by electric power having varying or reversing voltage levels, such as alternating current (AC) power as produced by an AC generator, inverter, and/or otherwise varying power, such as produced by a switching power source. In embodiments, a motor may include, without limitation, brushless DC electric motors, permanent magnet synchronous motor, switched reluctance motors, induction motors, or any combination thereof. According to embodiments, a motor may include a driving circuit such as electronic speed controllers and/or any other components for regulating motor speed, rotation direction, and/or dynamic braking (i.e. reverse thrust).

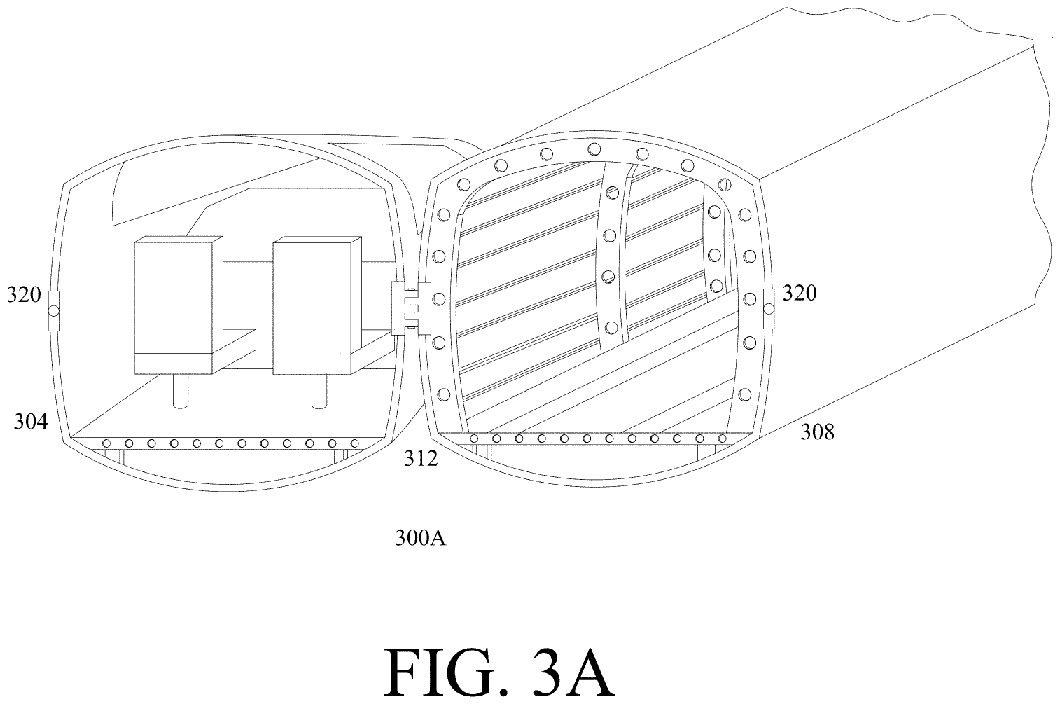

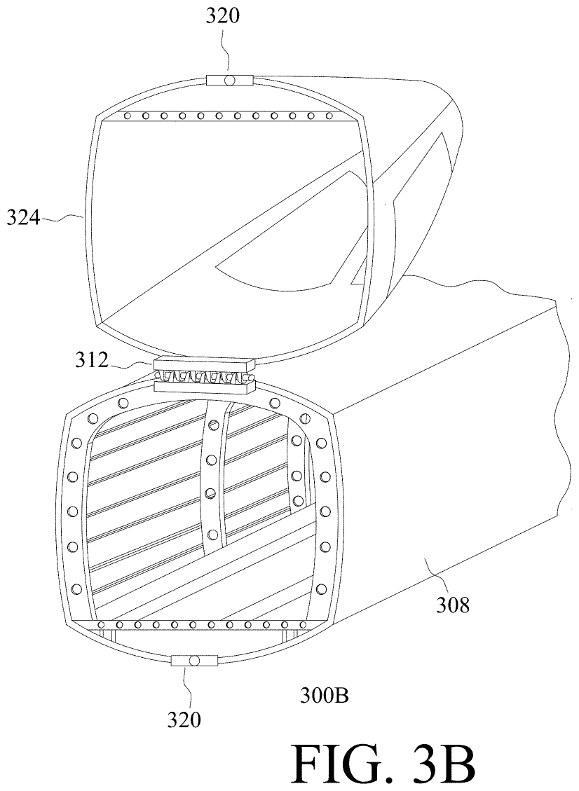

Dual-mode aircraft 100 may also comprise a nose 112 disposed at the front-most portion of aircraft. Nose 112 for the purposes of this disclosure refers to any portion of the aircraft forward of the aircraft's fuselage 116. Nose 112 may comprise a cockpit (for manned aircraft), canopy, aerodynamic fairings, windshield, and/or any structural elements required to support mechanical loads. Nose 112 may also comprise components generally found in aircraft cockpits like pilot seats, control interfaces, gages, displays, inceptor sticks, throttle controls, collective pitch controls, and/or communication equipment, to name a few. Nose 112, for the purposes of this disclosure may comprise a swing nose configuration. A swing nose may be characterized by the ability of the nose to move, manually or automatedly, into a differing orientation than its flight orientation to provide an opening for loading a payload into aircraft fuselage 116 from the front of the aircraft. Nose 112 may be configured to open in a plurality of orientations and directions. In a non-limiting example, nose 112 may swing horizontally to the left or right of the aircraft on a hinge similar to a door. The hinge mechanism will be discussed further later in this paper with reference to FIG. 3. Additionally, or alternatively, nose 112 may swing in a skyward direction rotating on a hinge disposed at the topmost portion of the nose 112 canopy, for example, like a hatch door. In yet another non-limiting example, nose 112 may rotate about an axis parallel to the nose-to-tail axis of the aircraft disposed at some point on the aircraft structure shut that nose 112 rolls out of its flight orientation to reveal an opening into fuselage 116. Additionally, or alternatively, a hinge may be disposed in any orientation along the outer mold line of nose 112 such that when actuated, manually or automatedly, nose 112 swings away from its flight orientation in a plane containing the longitudinal axis of the aircraft and the hinge, such as, for example, diagonally relative to the aircraft in level flight or on ground. Additionally, or alternatively, nose 112 may open in a manner that separates nose 112 into different, uncoupled components and moves those pieces away from each other in different directions to reveal an opening into fuselage 116.

Nose 112 may be configurable to open in a plurality of orientations and by a plurality of actuators. Dual-mode aircraft 100 may comprise provisions to remove nose 112, hardware, actuators, or a combination thereof to open in different orientations specific to aircraft's mission.

Nose 112 may comprise structural elements to provide physical stability during the entirety of the aircraft's flight envelope, while on ground, and during the swing of nose 112 out of flight orientation into open position. Structural elements may comprise struts, beams, formers, stringers, longerons, interstitials, ribs, structural skin, doublers, straps, spars, or panels, to name a few. Structural elements may also comprise pillars 120. In automobile construction especially, and for the purpose of aircraft cockpits comprising windows/windshields, pillars 120 may include vertical or near vertical supports around the window configured to provide extra stability around weak points in a vehicle's structure, such as an opening where a window is installed. Where multiple pillars 120 are disposed in an aircraft's structure, they are so named A, B, C, and so on named from nose to tail. Pillars, like any structural element for the purposes of this disclosure, may be disposed a distance away from each other, along the exterior of nose 112 and fuselage 116. Depending on manufacturing method of fuselage 116, pillars 120 may be integral to frame and skin, comprised entirely of internal framing, or alternatively, may be only integral to structural skin elements. Structural skin will be discussed in greater detail below in this paper.

Nose 112 may comprise a plurality of materials, alone or in combination, in its construction. Nose 112, in an illustrative embodiment may comprise a welded steel tube frame further configured to form the general shape of nose corresponding to the arrangement of steel tubes. The steel may comprise a plurality of alloyed metals, including but not limited to, a varying amount of manganese, nickel, copper, molybdenum, silicon, and/or aluminum, to name a few. The welded steel tubes may be covered in any of a plurality of materials suitable for aircraft skin. Some of these may include carbon fiber, fiberglass panels, cloth-like materials, aluminum sheeting, or the like, to name a few. It is to be noted that general aircraft construction methods will be discussed further below in this paper, but similar or the same methods may be used to construct nose 112 as any other part of aircraft, namely fuselage 116, among others, depending on function and location. Nose 112 may comprise aluminum tubing mechanically coupled in various and unique orientations. The mechanical fastening of aluminum members (whether pure aluminum or alloys) may comprise temporary or permanent mechanical fasteners appreciable by one of ordinary skill in the art including, but not limited to, screws, nuts and bolts, anchors, clips, welding, brazing, crimping, nails, blind rivets, pull-through rivets, pins, dowels, snap-fits, and clamps, to name a few. Nose 112 may additionally or alternatively use wood or another suitably strong yet light material for an internal structure.

Nose 112 may comprise monocoque or semi-monocoque construction. These methods of aircraft construction will be discussed at length later in this paper, but for the purpose of nose 112, the internal bracing structure need not be present if the aircraft skin provides sufficient structural integrity for aerodynamic force interaction, integral to skin if the preceding is untrue, or integral to aircraft skin itself.

“Carbon fiber”, for the purposes of this disclosure may refer to carbon fiber reinforced polymer, carbon fiber reinforced plastic, or carbon fiber reinforced thermoplastic (CFRP, CRP, CFRTP, carbon composite, or just carbon, depending on industry). Carbon fiber, as used herein, is an extremely strong fiber-reinforced plastic which contains carbon fibers. In general, carbon fiber composites consist of two parts, a matrix and a reinforcement. In carbon fiber reinforced plastic, the carbon fiber constitutes the reinforcement, which provides strength. The matrix can include a polymer resin, such as epoxy, to bind reinforcements together. Such reinforcement achieves an increase in CFRP's strength and rigidity, measured by stress and elastic modulus, respectively. In embodiments, carbon fibers themselves can each comprise a diameter between 5-10 micrometers and include a high percentage (i.e. above 85%) of carbon atoms. A person of ordinary skill in the art will appreciate that the advantages of carbon fibers include high stiffness, high tensile strength, low weight, high chemical resistance, high temperature tolerance, and low thermal expansion. According to embodiments, carbon fibers are usually combined with other materials to form a composite, when permeated with plastic resin and baked, carbon fiber reinforced polymer becomes extremely rigid. Rigidity, for the purposes of this disclosure, is analogous to stiffness, and is generally measured using Young's Modulus. Colloquially, rigidity may be defined as the force necessary to bend a material to a given degree. For example, ceramics have high rigidity, which can be visualized by shattering before bending. In embodiments, carbon fibers may additionally, or alternatively, be composited with other materials like graphite to form reinforced carbon-carbon composites, which include high heat tolerances over 2000 degrees Celsius (3632 degrees Fahrenheit). A person of skill in the art will further appreciate that aerospace applications require high-strength, low-weight, high heat resistance materials in a plurality of roles where carbon fiber exceeds such as fuselages, fairings, control surfaces, and structures, among others.

Illustrative embodiments may comprise a swinging nose 112 which does not comprise a cockpit and configured such that when nose 112 is actuated open the cockpit remains in its normal flight orientation. A stationary cockpit may comprise a simpler electromechanical design and may further be configured to contain all electronic and control interfaces in stationary portion of aircraft. Nose 112 comprising the cockpit may be configured to route all communication between controls disposed in cockpit and rest of aircraft through the hinge or apparatus which never separates from nose 112 and fuselage 116. Disposition of controls, electronics, and other communication provision will be discussed in further detail later in this paper with reference to FIGS. 3A and 3B.

Referring again to FIG. 1, a dual-mode aircraft may comprise wings, empennages, nacelles, control surfaces, fuselages, landing gear, among others, to name a few. Aircraft construction may comprise one or more of a plurality of construction methods that will be discussed further hereinbelow. In embodiments, a empennage may be disposed at the aftmost point of an aircraft body. The empennage may comprise the tail of the aircraft, further comprising rudders, vertical stabilizers, horizontal stabilizers, stabilators, elevators, trim tabs, among others. At least a portion of the empennage may be manipulated directly or indirectly by pilot commands to impart control forces on a fluid in which the aircraft is flying, most notably air. The manipulation of these empennage control surfaces may, in part, change an aircraft's heading in pitch, roll, and yaw. Pitch is about the transverse axis of an aircraft, centered at the center of gravity of an aircraft, parallel to a line connecting wing tip to wing tip. Roll is about the longitudinal axis of an aircraft with its origin at the center of gravity of an aircraft and parallel to the line connecting nose tip to empennage along fuselage. The yaw axis has its origin at the center of gravity and is directed down towards the bottom of the aircraft, a positive yaw angle, understood by a person of ordinary skill in the art to be when an aircraft's nose is moved to the right about its yaw axis, looking from aft, forward. A dual-mode aircraft may also comprise wings. Wings comprise structures which include airfoils configured to create a pressure differential resulting in lift. Wings are generally disposed on the left and right sides of the aircraft symmetrically, at a point between nose and empennage. Wings may comprise a plurality of geometries in planform view, swept swing, tapered, variable wing, triangular, oblong, elliptical, square, among others. A wing's cross section geometry comprises an airfoil. An “airfoil” as used herein, is a shape specifically designed such that a fluid flowing above and below it exert differing levels of pressure against the top and bottom surface. In embodiments, the bottom surface of an aircraft can be configured to generate a greater pressure than does the top, resulting in lift. A wing may comprise differing and/or similar cross-sectional geometries over its cord length or the length from wing tip to where wing meets the aircraft's body. One or more wings may be symmetrical about the aircraft's longitudinal plane, which comprises the longitudinal or roll axis reaching down the center of the aircraft through the nose and empennage, and the plane's yaw axis. Wings may comprise controls surfaces configured to be commanded by a pilot or pilots to change a wing's geometry and therefore its interaction with a fluid medium, like air. Control surfaces may comprise flaps, ailerons, tabs, spoilers, and slats, among others. The control surfaces may disposed on the wings in a plurality of locations and arrangements and in embodiments may be disposed at the leading and trailing edges of the wings, and may be configured to deflect up, down, forward, aft, or a combination thereof. An aircraft, including a dual-mode aircraft may comprise a combination of control surfaces to perform maneuvers while flying or on ground.

In general, a fixed wing aircraft and rotorcraft adhere to similar or the same physical principles, where a fixed wing aircraft may be pulled through a fluid by, for example, a jet engine, propelling an aircraft through a fluid while using wings to generate lift. A rotorcraft may use a different power source, which will be discussed below to propel a rotor, or set of airfoils, through a fluid medium, like air, generating lift. Rotorcraft, like helicopters, quadcopters, and the like may be well suited for hovering, due to their propulsion technique, where a fixed wing aircraft may be well suited for higher flight speeds. A dual-mode aircraft may take the inherent benefits from both aircraft types and integrate them.

Referring again to FIG. 1, a dual-mode aircraft may include an energy source. The energy source may include any device providing energy to the plurality of propulsors; in an embodiment, the energy source provides electric energy to the plurality of propulsors. The energy source may include, without limitation, a generator, a photovoltaic device, a fuel cell such as a hydrogen fuel cell, direct methanol fuel cell, and/or solid oxide fuel cell, or an electric energy storage device; electric energy storage device may include without limitation a capacitor and/or inductor. The energy source and/or energy storage device may include at least a battery, battery cell, and/or a plurality of battery cells connected in series, in parallel, or in a combination of series and parallel connections such as series connections into modules that are connected in parallel with other like modules. Battery and/or battery cell may include, without limitation, Li ion batteries which may include NCA, NMC, Lithium iron phosphate (LiFePO4) and Lithium Manganese Oxide (LMO) batteries, which may be mixed with another cathode chemistry to provide more specific power if the application requires Li metal batteries, which have a lithium metal anode that provides high power on demand, Li ion batteries that have a silicon or titanite anode. In embodiments, the energy source may be used to provide electrical power to an electric aircraft or drone, such as an electric aircraft vehicle, during moments requiring high rates of power output, including without limitation takeoff, landing, thermal de-icing and situations requiring greater power output for reasons of stability, such as high turbulence situations, as described in further detail below. The battery may include, without limitation a battery using nickel based chemistries such as nickel cadmium or nickel metal hydride, a battery using lithium ion battery chemistries such as a nickel cobalt aluminum (NCA), nickel manganese cobalt (NMC), lithium iron phosphate (LiFePO4), lithium cobalt oxide (LCO), and/or lithium manganese oxide (LMO), a battery using lithium polymer technology, lead-based batteries such as without limitation lead acid batteries, metal-air batteries, or any other suitable battery. A person of ordinary skill in the art, upon reviewing the entirety of this disclosure, will be aware of various devices of components that may be used as an energy source.

Continuing to view FIG. 1, configuration of an energy source containing connected modules may be designed to meet an energy or power requirement and may be designed to fit within a designated footprint in an electric aircraft in which the system may be incorporated. energy source may be used to provide a steady supply of electrical power to a load over the course of a flight by a vehicle or other electric aircraft; the energy source may be capable of providing sufficient power for “cruising” and other relatively low-energy phases of flight. An energy source may be capable of providing electrical power for some higher-power phases of flight as well, particularly when an energy source is at a high state of charge and/or state of voltage, as may be the case for instance during takeoff. An energy source may be capable of providing sufficient electrical power for auxiliary loads including without limitation, lighting, navigation, communications, de-icing, steering or other systems requiring power or energy. An energy source may be capable of providing sufficient power for controlled descent and landing protocols, including, without limitation, hovering descent or runway landing.

Still referring to FIG. 1, an energy source may include a cell such as a battery cell, or a plurality of battery cells making a battery module. An energy source may be a plurality of energy sources. The module may include batteries connected in parallel or in series or a plurality of modules connected either in series or in parallel designed to deliver both the power and energy requirements of the application. Connecting batteries in series may increase the voltage of an energy source which may provide more power on demand. High voltage batteries may require cell matching when high peak load is needed. As more cells are connected in strings, there may exist the possibility of one cell failing which may increase resistance in the module and reduce the overall power output as the voltage of the module may decrease as a result of that failing cell. Connecting batteries in parallel may increase total current capacity by decreasing total resistance, and it also may increase overall amp-hour capacity. The overall energy and power outputs of an energy source may be based on the individual battery cell performance or an extrapolation based on the measurement of at least an electrical parameter. In an embodiment where an energy source includes a plurality of battery cells, the overall power output capacity may be dependent on the electrical parameters of each individual cell. If one cell experiences high self-discharge during demand, power drawn from an energy source may be decreased to avoid damage to the weakest cell. An energy source may further include, without limitation, wiring, conduit, housing, cooling system and battery management system. Persons skilled in the art will be aware, after reviewing the entirety of this disclosure, of many different components of an energy source.

Still viewing FIG. 1, dual-mode aircraft may include multiple propulsion sub-systems, each of which may have a separate energy source powering a separate plurality of propulsors. For instance, and without limitation, each propulsor of plurality of propulsors may have a dedicated energy source of at least an energy source. Alternatively or additionally, a plurality of energy sources may each provide power to two or more propulsors, such as, without limitation, a “fore” energy source providing power to propulsors located toward the front of an aircraft, while an “aft” energy source provides power to propulsors located toward the rear of the aircraft. As a further non-limiting example, a single propulsor or group of propulsors may be powered by a plurality of energy sources. For example, and without limitation, two or more energy sources may power one or more propulsors; two energy sources may include, without limitation, at least a first energy source having high specific energy density and at least a second energy source having high specific power density, which may be selectively deployed as required for higher-power and lower-power needs. Alternatively, or additionally, a plurality of energy sources may be placed in parallel to provide power to the same single propulsor or plurality of propulsors. Alternatively or additionally, two or more separate propulsion subsystems may be joined using intertie switches (not shown) causing the two or more separate propulsion subsystems to be treatable as a single propulsion subsystem or system, for which potential under load of combined energy sources may be used as the electric potential as described below. Persons skilled in the art, upon reviewing the entirety of this disclosure, will be aware of various combinations of energy sources 104 that may each provide power to single or multiple propulsors in various configurations.

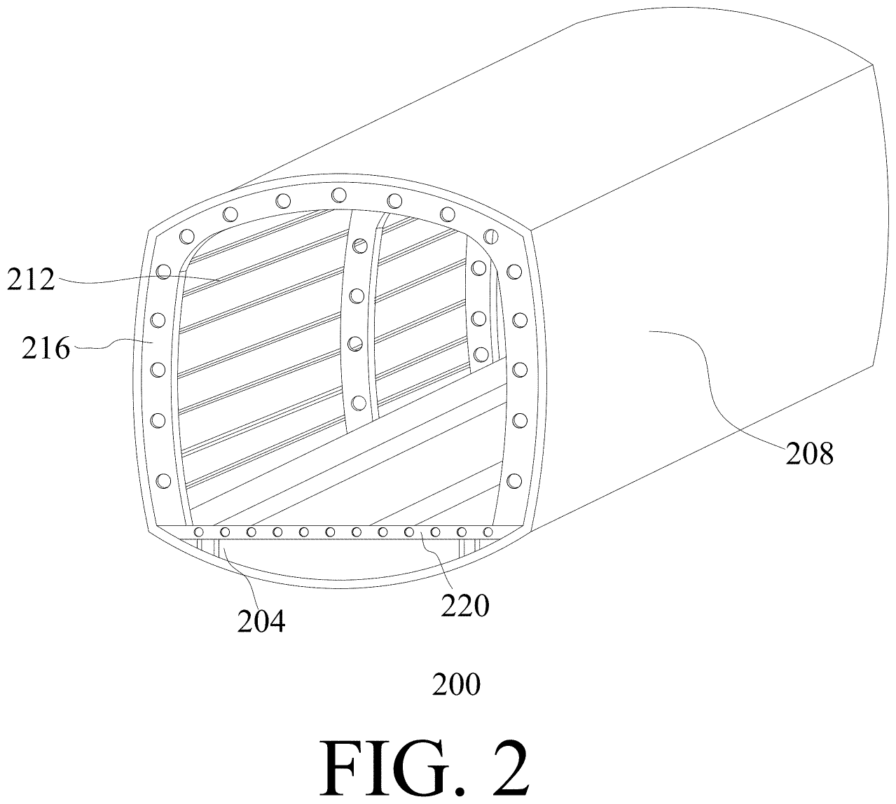

Referring now to FIG. 2, an illustrative embodiment of aircraft fuselage 200 (which is the same as, or similar to, fuselage 116) is presented. A fuselage, for the purposes of this disclosure, refers to the main body of an aircraft, or in other words, the entirety of the aircraft except for the cockpit, nose, wings, empennage, nacelles, any and all control surfaces, and generally contains an aircraft's payload. Fuselage 200 may comprise structural elements 204 that physically support the shape and structure of an aircraft. Structural elements 204 may take a plurality of forms, alone or in combination with other types. Structural elements 204 vary depending on the construction type of aircraft and specifically, the fuselage.

Fuselage 200 may comprise a truss structure. A truss structure is often used with a lightweight aircraft and comprises welded steel tube trusses. A truss, as used herein, is an assembly of beams that create a rigid structure, often in combinations of triangles to create three-dimensional shapes. A truss structure may alternatively comprise wood construction in place of steel tubes, or a combination thereof. In embodiments, structural elements 204 can comprise steel tubes and/or wood beams. Aircraft skin 208 may be layered over the body shape constructed by trusses. Aircraft skin 208 may comprise a plurality of materials such as plywood sheets, aluminum, fiberglass, and/or carbon fiber, the latter of which will be addressed in greater detail later in this paper.

In embodiments, aircraft fuselage 200 may comprise geodesic construction. Geodesic structural elements include stringers 212 wound about formers 216 (which may be alternatively called station frames 216) in opposing spiral directions. A stringer 212, for the purposes of this disclosure is a general structural element that comprises a long, thin, and rigid strip of metal or wood that is mechanically coupled to and spans the distance from, station frame 216 to station frame 216 to create an internal skeleton on which to mechanically couple aircraft skin 208. A former (or station frame) 216 can include a rigid structural element that is disposed along the length of the interior of aircraft fuselage 200 orthogonal to the longitudinal (nose to tail) axis of the aircraft and forms the general shape of fuselage 200. A former 216 may comprise differing cross-sectional shapes at differing locations along fuselage 200, as the former 216 is the structural element that informs the overall shape of a fuselage 200 curvature. In embodiments, aircraft skin 208 can be anchored to formers 216 and strings 212 such that the outer mold line of the volume encapsulated by the formers and stringers comprises the same shape as aircraft 208 when installed. In other words, former(s) 216 may form a fuselage's ribs, and the stringers 212 may form the interstitials between such ribs. The spiral orientation of stringers 212 about formers 216 provide uniform robustness at any point on an aircraft fuselage such that if a portion sustains damage, another portion may remain largely unaffected. Aircraft skin 208 would be mechanically coupled to underlying stringers 212 and formers 216 and may interact with a fluid, such as air, to generate lift and perform maneuvers.

According to embodiments, fuselage 200 can comprise monocoque construction. Monocoque construction can include a primary structure that forms a shell (or skin in an aircraft's case) and supports physical loads. Monocoque fuselages are fuselages in which the aircraft skin or shell is also the primary structure. In monocoque construction aircraft skin 208 would support tensile and compressive loads within itself and true monocoque aircraft can be further characterized by the absence of internal structural elements 204. Aircraft skin 208 in this construction method is rigid and can sustain its shape with no structural assistance form underlying skeleton-like elements. Monocoque fuselage may comprise aircraft skin 208 made from plywood layered in varying grain directions, epoxy-impregnated fiberglass, carbon fiber, or any combination thereof.

According to embodiments, fuselage 200 can include a semi-monocoque construction. Semi-monocoque construction, as used herein, partially monocoque construction, discussed above. In semi-monocoque construction, aircraft fuselage 200 may derive some structural support from stressed aircraft skin 208 and some structural support from underlying frame structure made of structural elements 204. For the purposes of this disclosure, the illustrative embodiment FIG. 2 is represented as a semi-monocoque fuselage. Formers or station frames 216 can be seen running transverse to the long axis of fuselage 200 with circular cutouts which are generally used in real-world manufacturing for weight savings and for the routing of electrical harnesses and other modern on-board systems. In a semi-monocoque construction, stringers 212 are the thin, long strips of material that run parallel to fuselage's long axis. Stringers 212 can be mechanically coupled to formers 212 permanently, such as with rivets. Aircraft skin 208 can be mechanically coupled to stringers 212 and formers 216 permanently, such as by rivets as well. A person of ordinary skill in the art will appreciate that there are numerous methods for mechanical fastening of the aforementioned components like crews, nails, dowels, pins, anchors, adhesives like glue or epoxy, or bolts and nuts, to name a few. A subset of fuselage under the umbrella of semi-monocoque construction is unibody vehicles. Unibody, which is short for “unitized body” or alternatively “unitary construction”, vehicles are characterized by a construction in which the body, floor plan, and chassis form a single structure. In the aircraft world, unibody would comprise the internal structural elements like formers 216 and stringers 212 are constructed in one piece, integral to the aircraft skin 208 (body) as well as any floor construction like a deck.

Stringers 212 and formers 216 which account for the bulk of any aircraft structure excluding monocoque construction can be arranged in a plurality of orientations depending on aircraft operation and materials. FIG. 2 and this disclosure serve in no way to limit the arrangement of load-bearing members used in the construction of dual-mode aircraft 100. Stringers 212 may be arranged to carry axial (tensile or compressive), shear, bending or torsion forces throughout their overall structure. Due to their coupling to aircraft skin 208, aerodynamic forces exerted on aircraft skin 208 will be transferred to stringers 212. The location of said stringers 212 greatly informs the type of forces and loads applied to each and every stringer, all of which may be handled by material selection, cross-sectional area, and mechanical coupling methods of each member. The same assessment may be made for formers 216. In general, formers 216 are significantly larger in cross-sectional area and thickness, depending on location, than stringers 212. Both stringers 212 and formers 216 may comprise aluminum, aluminum alloys, graphite epoxy composite, steel alloys, titanium, or an undisclosed material alone or in combination.

Stressed skin, when used in semi-monocoque construction is the concept where the skin of an aircraft bears partial, yet significant, load in the overall structural hierarchy. In other words, the internal structure, whether it be a frame of welded tubes, formers and stringers, or some combination, is not sufficiently strong enough by design to bear all loads. The concept of stressed skin is applied in monocoque and semi-monocoque construction methods of fuselage 200. Monocoque comprises only structural skin, and in that sense, aircraft skin 208 undergoes stress by applied aerodynamic fluids imparted by the fluid. Stress as used in continuum mechanics can be described in pound-force per square inch (lbf/in²) or Pascals (Pa). In semi-monocoque construction stressed skin bears part of the aerodynamic loads and additionally imparts force on the underlying structure of stringers 212 and formers 216.

With continued reference to FIG. 2, beam 220 is illustrated. A person of ordinary skill in the art will appreciate beam 220 to be supporting the floor, or in other words the surface on which a passenger, operator, passenger, payload, or other object would rest on due to gravity when dual-mode aircraft 100 is in its level flight orientation or sitting on ground. Beam 220 acts similarly to stringer 212 in that it is configured to support axial loads in compression due to a load being applied parallel to its axis in its illustrated orientation, due to, for example, a heavy object being placed on the floor of fuselage 200. Strut 224 is also illustrated in an exemplary embodiment. Strut 224 may be disposed in or on any portion of fuselage 200 that requires additional bracing, specifically when disposed transverse to another structural element 204, like beam 224, that would benefit from support in that direction, opposing applied force. Strut 224 may be disposed in a plurality of locations and orientations within fuselage 200 as necessitated by operational and constructional requirements.

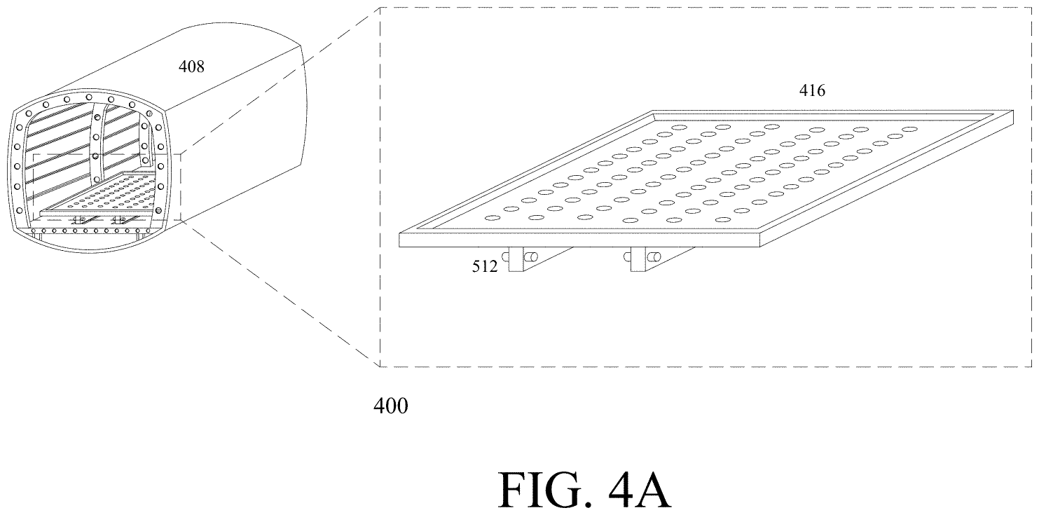

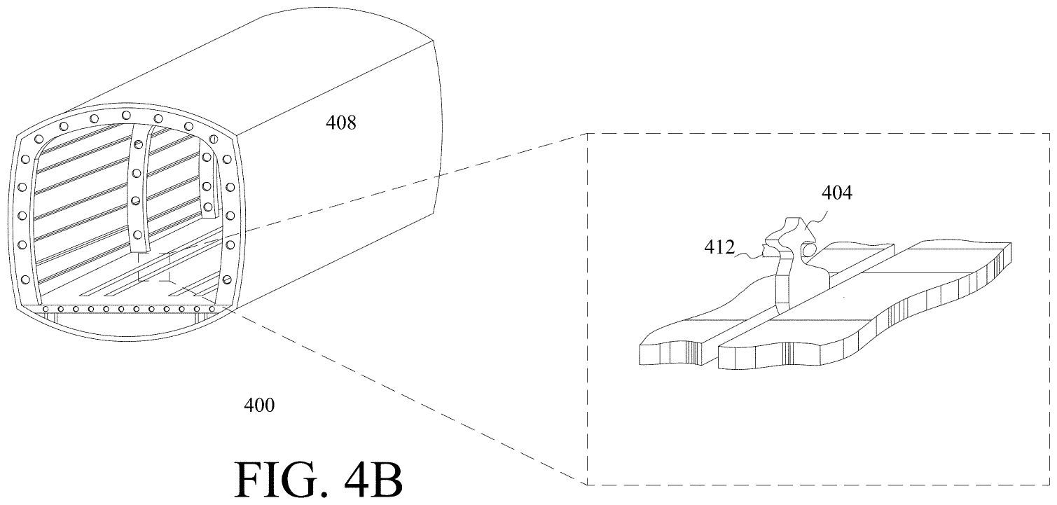

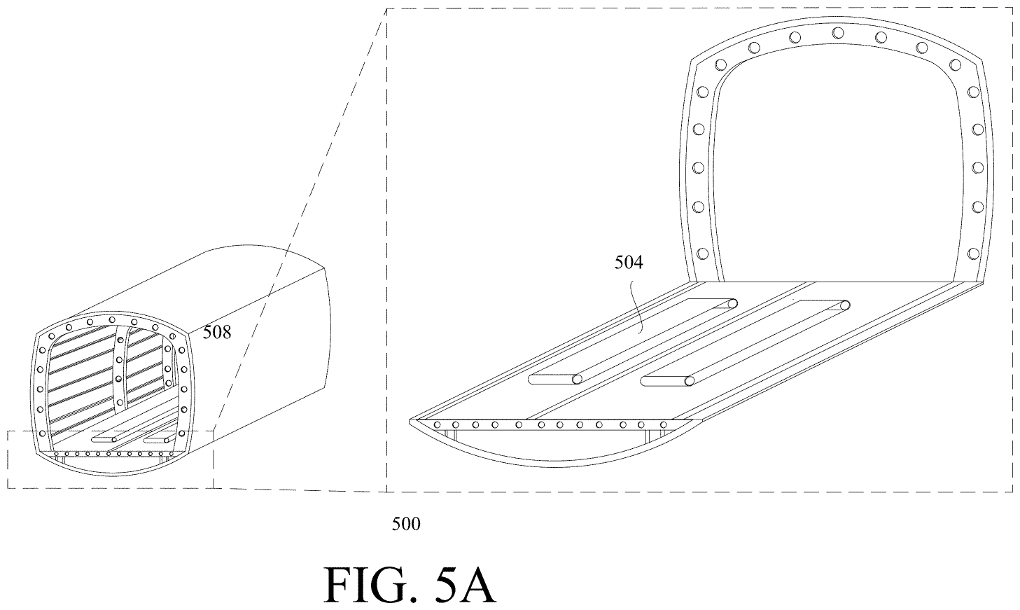

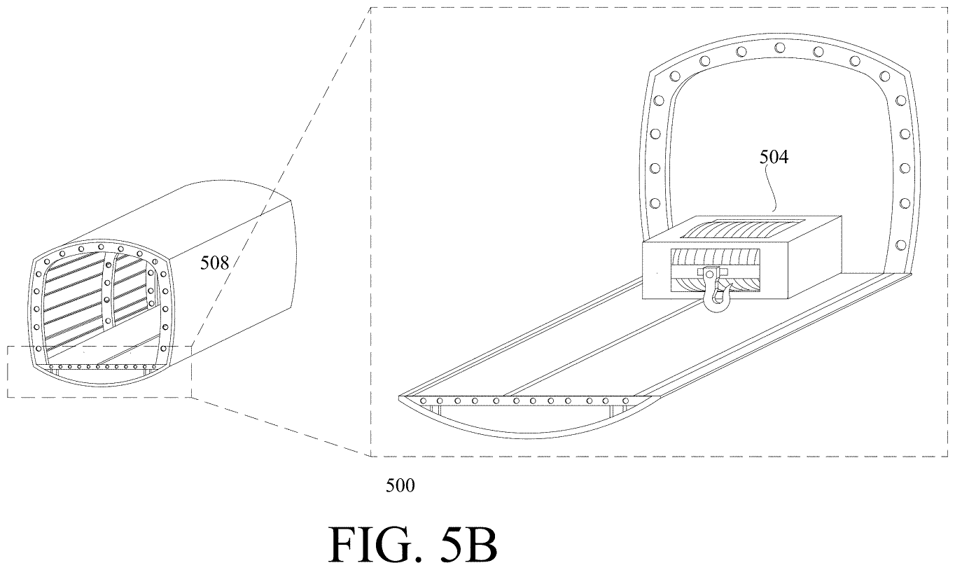

It is to be noted with reference FIG. 2 that an illustrative embodiment is presented only, and this disclosure in no way limits the form or construction method of a system and method for loading payload into an eVTOL aircraft. In embodiments, fuselage 200 may be configurable based on the needs of the eVTOL per specific mission or objective. The general arrangement of components, structural elements 204, and hardware associated with storing and/or moving a payload may be added or removed from fuselage 200 as needed, whether it is stowed manually, automatedly, or removed by personnel altogether. Fuselage 200 may be configurable for a plurality of storage options. Bulkheads and dividers may be installed and uninstalled as needed, as well as longitudinal dividers where necessary. Bulkheads and dividers may be installed using integrated slots and hooks, tabs, boss and channel, or hardware like bolts, nuts, screws, nails, clips, pins, and/or dowels, to name a few. Fuselage 200 may also be configurable to accept certain specific cargo containers, or a receptable that can, in turn, accept certain cargo containers. The receptacle that may, for example, be a configurable pallet, will be discussed further with reference to FIGS. 4 and 5.

Referring now to FIG. 3A, an illustrative embodiment of an aircraft side swing nose 304 in the open position and fuselage 308 are shown in a partial isometric view 300A and 300B. In embodiments, swing nose configuration 300A comprises side swing nose 304. In the illustrative embodiment of FIG. 3A, side swing nose 304 may include the cockpit, thus two pilot seats have been illustrated for emphasis. Fuselage 308 can be seen in an illustrative embodiment and is similar to, or the same as fuselage 116 and 200. Fuselage 308 may comprise any configuration previously disclosed or another configuration for receiving payloads in any way. Side swing nose 304 may utilize a mechanism for actuating, securing, and partially or fully supporting side swing nose 304 in the arc of its swing, and in open or closed positions. Side swing nose 304 may comprise hinge 312 in one such configuration. Hinge 312 may manually or automatedly open and close side swing nose 304 from remainder of aircraft fuselage 308. Hinge 312 may be a combination of simple machines comprising two mating sets of cylindrical openings that share an axis and interlace with a cylinder pushed through to mechanically couple them together, and a flange disposed on each of the sets of mating cylindrical sections arranged along the axis of cylinder such that flanges may be further coupled to side swing nose 304 and fuselage 308. Hinge 312 may be similar to or the same as a hinge commonly found on doors, or comprise a more robust construction configured to house mechanical actuators like servo motors, hydraulic systems, pneumatic systems, or the like to aid, or fully open and close side swing nose 304. Hinge 312 may also comprise mechanical, electromechanical, hydraulic, and/or pneumatic systems or components configured to hinder unintended actuation of hinge 312, analogized to a locking mechanism. A locking mechanism may comprise mechanical features like slots and bosses to stop accidental opening and closing of side swing nose 304 such that one component of hinge may comprise a boss like a pin, protrusion, or complex cross-sectional polygon disposed in or on it that can be actuated in or out of hinge and mate with a receptable disposed on or in the other component of hinge. When the boss on a first component of hinge 312 mates with receptable on a second component of hinge 312 may prevent movement of sides of hinge 312 relative to the other like a deadbolt in a modern door lock. Hinge 312 may comprise multiple mechanical features or systems that work in tandem or separately to keep hinge 312 in a certain position. Additionally, or alternatively, hinge 312 may comprise more complex systems configured to actuate hinge 312 open or closed and/or hold hinge 312 in a certain position. These systems for hinge actuation and/or hinge locking may comprise various forms of hydraulic, pneumatic, and/or electromechanical systems.

In general, hydraulic systems comprise components that may be disposed in or on side swing nose 304, fuselage 308, and/or hinge 312, as necessary. A hydraulic system may comprise a reservoir (for hydraulic fluid), pump, motor, hydraulic cylinder, and control valves. In a non-limiting embodiment, a reservoir, pump, motor and valves may be disposed in the fuselage and comprise tubes routing to a hydraulic cylinder disposed in/on/near hinge 312 or opening of fuselage 308 and side swing nose 304 such that when hydraulic cylinder is pumped full of hydraulic fluid, a piston is extended, and side swing nose 304 is actuated to the open position. More complex systems of hydraulic cylinders may comprise balloons or other cavities disposed in or on hinge 312 configured to fill with fluid and move hinge 312 in desired direction to open or close side swing nose 304.

Hinge 312 may also comprise a pneumatic system that, in general, is configured similarly to hydraulic system in that a pressurized fluid is moved to actuate a mechanical component in at least a first direction. Pneumatic systems may include any component suitable to compress a gas, like air, a pump and a pneumatic cylinder containing a piston. When compressed air is pumped into pneumatic cylinder, it pushes a first end of piston in a first direction further imparting force on whatever object the second end of piston is mechanically coupled to. In an arrangement similar to the system disclosed with reference to a hydraulic system, a pneumatic system may be utilized to push open and pull closed the side swing nose 304. Additionally, or alternatively, a pneumatic system may be integral to hinge 312 instead of disposed separately from it with a first end coupled to fuselage 308 and a second end to side swing nose 304. A pneumatic system may pump compressed air into a chamber disposed in hinge 312, thereby pushing some mechanical component out of chamber, actuating the hinge 312 open, and conversely, compressed air may be pumped into a second chamber, thereby actuating hinge 312 closed again. When compressed air is present in pneumatic cylinder chamber, hinge 312 may not be manually actuated, thereby providing a locking mechanism to hold hinge 312 in the locked position, whatever that position may be relative to side swing nose 304 and fuselage 308.

Similarly, electromechanical actuators may be comprised within swing nose configuration 300A. An electromechanical actuator may further comprise an electric motor, stepper motor, or servo motor. A stepper motor is a brushless electric motor that divides a full rotation into a number of equal steps. The motor's position can be commanded to move and hold a step with position sensors as long as motor is specifically sized for torque and speed in its application. A servo motor is a rotary or linear actuator comprising a closed-loop servomechanism, that uses position feedback to control its motion and final position. The motor is paired with a position encoder to provide position and speed feedback. A motor as disclosed above may be mechanically coupled to fuselage 308 and further mechanically coupled to side swing nose 304 and configured to actuate side swing nose 304 away from fuselage 308 to open loading opening when commanded to do so. Any of the electromechanical actuators disclosed herein can be comprised within hinge 312 and due to the nature of a hinge containing a cylinder about which the flanges rotate, an output shaft of a motor may be coupled to or be the cylinder about which the hinge rotates, itself.

Side swing configuration 300A may also comprise a dedicated and separate primary locking mechanism 320. Primary locking mechanism 320 may be separate and distinct from hinge 312 or integrated into hinge 312 as previously disclosed. Primary locking mechanism 320 may be disposed in or on side swing nose 304 and/or fuselage 308. Primary locking mechanism 320 may be similar to the mechanisms disposed in or on hinge 312 like a bolt and latch, hook and loop, or another mechanical method of coupling side swing nose 304 and fuselage 308. Primary locking mechanism 320 may disposed on any portion of side swing nose 304 that comes in contact with another portion of fuselage 308, like for example, at the 9 o'clock position when looking aft forward down the length of aircraft. In this configuration, primary locking mechanism 320 would comprise a first component on side swing nose 304 and a second component disposed on fuselage 308 that come in contact when the nose is in the closed position. Primary locking mechanism 320 may be actuated open and closed (or locked and unlocked, engaged and disengaged, etc.) manually or automatedly. Personnel may need to interface with primary locking mechanism 320 from the exterior or interior of aircraft or be actuated by a pilot or operator in the cockpit. Additionally, or alternatively, personnel may wirelessly communicate with primary locking mechanism 320 to actuate open or closed remotely through use of electromagnetic radiation, like radio transceivers. Primary locking mechanism 320 may be one of a plurality of mechanisms disposed in and/or around side swing nose 304 and fuselage 308 that work in tandem or individually to prevent unintended opening of side swing nose 304. Primary locking mechanism 320 may comprise electromagnetic features that serve to keep side swing nose 304 from opening unintentionally. A first electromagnetic pole may be configured to attract a second and opposite pole when an electric current is flowed through it. An electromagnet may be utilized easily in this application because personnel, a pilot for example, may shut down an electric current through electromagnet to removed magnetic field and release primary locking mechanism 320 allowing side swing nose 304 to move away from fuselage 308.

With reference to FIG. 3B an illustrative embodiment of an aircraft with a swing nose in the open position and fuselage are shown in a partial isometric view. Upward swing nose aircraft 300B may comprise upward swing nose 324 as illustrated in the open position. Upward swing nose 324 may be similar to side swing nose 304 with reference to side swing nose aircraft 300A. In an illustrative embodiment depicted in FIG. 3B may comprise the same or similar components as disclosed with reference to FIG. 3A. Hinge 312 may be present in upward swing nose aircraft 300B but disposed in a different orientation than side swing nose aircraft 300A. Hinge 312 in FIG. 3B may be disposed at the topmost position of upward swing nose 324 and fuselage 308. Hinge 312 may comprise provisions for automated or manual actuation similar to side swing nose aircraft 300A. Primary locking mechanism 320 may be present yet again as it was in FIG. 3A, illustrated here disposed at the topmost point of upward swing nose 324 (illustrated at the bottommost portion because it is inverted in the open position) and fuselage 308. Primary locking mechanism 308 may be disposed in one of a plurality of locations that mechanically couple when the nose is in the closed position or be one of a plurality of mechanisms employed simultaneously and disposed in or on upward swing nose 324 and fuselage 308.

With reference to FIGS. 3A and 3B, a nose portion of an aircraft may be configurable to accept different hinge mechanisms. The hinge mechanisms may be similar to hinge 312 but be disposed in different locations. Nose 112 may include features that allow for swapping of hinge and locking mechanisms to allow for a plurality of different swinging arcs of nose 112. In a non-limiting example, a side swing nose aircraft 300A may include hardware and software that allow for personnel to manually or automatedly reconfigure hinge 312 and locking mechanism 320 to convert aircraft to upward swing nose aircraft 300B. Hardware that may be used to enabled this reconfiguration may include adapters mechanically coupled to mating surfaces of nose 112 and fuselage 116 with a plurality of mounting hardware for hinge and locking mechanism mounted in a plurality of locations. This is of course only an example of reconfigurable swing-nose enabling hardware and should not be taken as a limitation of the manner of nose 112 manipulation. Nose 112, as previously disclosed could roll out of its flight orientation about some pivot point that may employ a different mechanism than hinge 312 but perform the same function. Additionally, locking mechanism 320 may not necessarily comprise two parts that are disposed on components sought to be fixed together, but instead interface in a different undisclosed way. In a non-limiting example, this mechanism may comprise features disposed on nose 112 that may be at least in part, captured by a feature on or in fuselage 116. Any mechanism that may prevent an unintended opening of nose 112 from fuselage 116 and be suitable for flight may be utilized.

With continued reference to FIGS. 3A and 3B, side swing nose aircraft 300A, upward swing nose aircraft 300B, may comprise suitable materials for high-strength, low-weight applications one of ordinary skill in the art would appreciate there is a vast plurality of materials suitable for construction of this aerostructures system in an eVTOL aircraft. Some materials used may include aluminum and aluminum alloys, steel and steel alloys, titanium and titanium alloys, carbon fiber, fiberglass, various plastics including acrylonitrile butadiene styrene (ABS), high-density polyethylene (HDPE), composites, laminates, and even wood, to name a few. Side swing or upward swing noses may require extra strength relative to other portions of eVTOL aircraft due to high stresses localized at hinge 312, or the interface of nose and fuselage. Due to this requirement of extra strength, material selection, design, or a combination thereof may necessitate thickening of members in that area and/or the choice of differing, stronger materials in that area as opposed to the rest of structures. Beams, formers, struts, straps, doublers, stringers, or longerons, to name a few, may increase strength in localized areas of an eVTOL to account for increased levels of tension and compression during a nose's swing through its arc path. Specific areas of high stress in an aircraft's aerostructure may employ different structural designs than other portions of eVTOL aircraft like I-beams, complex composite materials, additively manufactured honeycomb structures, or the like, to name a few.

Now referring to FIGS. 4A and 4B, a mechanism for securing payload in an eVTOL fuselage is presented. Fuselage 408 may be similar to, or the same as fuselage 116 and fuselage 308. Fuselage 408 may be configured to receive a payload pallet 416. Payload pallet 416 may comprise pin 412 disposed in or on it and may be retained within fuselage 408 by payload latch 404. In an illustrative embodiment, payload latch 412 may comprise a hook that engages around pin 412 arresting payload pallet 416 from movement relative to fuselage 408.

Referring to FIG. 4A, payload pallet 416 may be further configured to accept a plurality of payload types. A payload, for the purposes of this disclosure is a part of a vehicle's load, especially of an aircraft, from which revenue is derived, and further, items that the aircraft will move from one place to another that are not the pilot(s). That is to say, an eVTOL aircraft's payload may include passengers. Payload pallet 416 may be configured to load a plurality of cargo types and/or passenger seating on or in it. Payload pallet 416 may be reconfigurable such that one pallet may be ready to accept shipping crates for one flight, and at the drop-off location, be reconfigured such that the same pallet can then be adjusted to accept passenger seats for the next flight. Additionally, or alternatively, a first payload pallet 416 may comprise hardware for quick removal (with cargo or passengers on or off of it) and be easily replaced with a second payload pallet 416 configured to move the same type of payload or a different type of payload. Payload pallet 416 may comprise hardware one of ordinary skill in the art of freighting would appreciate as commonplace in the shipping of cargo. Payload pallet 416 may comprise tracks, rollers, channels, D-rings, loops, walls, ridges, dividers, or the like, to name a few. Payload pallet 416 may retain cargo on top and within it by a plurality of methods known to one of ordinary skill in the art like ratchet straps, nets, retainment by pallet geometry like cutouts or slots where cargo press fits in, tiedowns, clips, ropes, or hooks, to name a few. Payload pallet 416 may be configured to hold down a plurality of types of cargo including, but not limited to, crates, boxes, oblong or irregular packages, smaller packages, or pallet-specific cargo crates designed to fit payload pallet 416. It is to be noted that payload pallet 416 is not restricted to cargo designed to be shipped or otherwise transported specifically on payload pallet 416 but may accept a plurality of industry-known shipping containers. Payload pallet 416 may comprise multilevel container retainment hardware like shelving, for example. Shelving may be configured to accept small packages on the order of a foot cubed or less, for example. It should be noted that no limitation on container size is attributed to payload pallet 416 other than fitting within fuselage 408. As one of ordinary skill in the art would appreciate, modern freight airliners may comprise multiple decks for cargo stowage during flight, and so may payload pallet 416, in a non-limiting exemplary configuration.

Still referring to FIG. 4A, payload pallet 416 may be configured to receive passenger seats additionally or alternatively to cargo. Payload pallet 416 may comprise conventional aircraft passenger seats, a unique passenger seat designed for this application, or a combination thereof. Payload pallet 416 may comprise both passenger seating and cargo retainment equipment simultaneously, and in a plurality of orientations and arrangements. For example, and in a non-limiting embodiment, the forwardmost portion of payload pallet may comprise passenger seating, the middle portion be configured to receive cargo crates, and the aftmost portion comprising more passenger seating. Payload pallet 416 may comprise hardware disposed in a grid pattern on the floor pan such that a virtually limitless arrangement of passenger seating, cargo retainers, and the like can be configured. To this end, the hardware disposed in a grid on payload pallet 416 floor pan may be configured to accept any type of payload required, that is to say, the interface between passenger seating and payload pallet 416 and the interface between any cargo retaining hardware and payload pallet 416 may be similar or the same.

Still referring to FIG. 4A, payload pallet 416, which, as disclosed above, is configurable to accept a plurality of cargo types and passengers, may also comprise a latching element 412. Latching element 412, as illustrated in FIG. 4A, may comprise a pin, but alternatively or additionally may comprise a loop, D-ring, slot, channel, opening, hole, or another undisclosed type, to name a few. Latching element 412 may be disposed in or on a surface of payload pallet 416, alone or one amongst a plurality of latching elements 412. Latching element 412 may be disposed evenly or irregularly spaced along a surface or multiple surfaces of payload pallet 416. Latching element 412 may comprise a component mechanically coupled to payload pallet 416 or a component integral to payload pallet 416 itself. One or ordinary skill in the art would appreciate that latching element 412 may be disposed in a plurality of locations on payload pallet 416 and may also be oriented in a plurality of directions and comprise a plurality of shapes not necessarily presented in FIGS. 4A and 4B.

Referring now to FIG. 4B, latching mechanism 404 can be seen presented in a breakout view of fuselage 408 within payload fuselage 400. In a non-limiting example, latching mechanism 404 may comprise a hook to capture at least a portion of latching element 412. One of ordinary skill in the art would appreciate that the mechanical shape and properties of one latching element 412 may inform the mechanical shape and properties of latching mechanism 404 that captures at least a portion of it. In other words, and in a non-limiting example, a plurality of latching elements 412 may require a plurality of latching mechanisms 404. This example in no way limits the embodiments the latching mechanism or element may take, and in no way precludes the use of latching mechanism 404 with any one or more of a plurality latching elements 412 and vice versa.

Referring again to FIG. 4B, latching mechanism 404 may be actuated manually or automatedly. Latching mechanism 404 may comprise spring loaded elements that allow for payload pallet 416 to move past it in a first direction, actuate latching mechanism 404 on the way by, and latch on to latching element 412 and hinder movement of payload pallet 416 in a second direction. Latching mechanism 404 may be mechanically actuated to the capture position by a moving payload pallet 416 as previously described or manually by personnel operating eVTOL or personnel loading payload into fuselage 408. Additionally, or alternatively, latching mechanism 404 may be actuated automatedly by a plurality of methods. In a non-limiting example, a pilot from the cockpit may command latching mechanism 404 to the capture position or the release position electronically through any of the actuation systems disclosed above in this paper like hydraulics, pneumatics, or electromechanical, to name a few. These disclosed actuation systems may drive latching mechanism 404 to a capture position, release position, or any other intermediate or extreme position relative to latching element 412 and fuselage 408.

With continued reference to FIGS. 4A and 4B, latching mechanism 404, latching element 412, payload pallet 416, may comprise suitable materials for high-strength, low-weight applications one of ordinary skill in the art of aircraft manufacture, passenger airlines, airline freighting would appreciate there is a vast plurality of materials suitable for construction of this payload system in an eVTOL aircraft. Some materials used may include aluminum and aluminum alloys, steel and steel alloys, titanium and titanium alloys, carbon fiber, fiberglass, various plastics including acrylonitrile butadiene styrene (ABS), high-density polyethylene (HDPE), and even wood, to name a few.

Referring now to FIGS. 5A and 5B, conveyor system 500 is presented. Conveyor system 500 may comprise conveyor mechanism 504 and be housed, at least in part, by fuselage 508. Conveyor mechanism 504 may be configured to assist personnel, other transportation equipment, or otherwise transport a payload into fuselage 508 for stowage. Conveyor mechanism 504 may be further configured to be manually or automated activated to pull, push, roll, or otherwise move cargo, people, or a combination thereof from the exterior of the aircraft to a stowage location in an eVTOL aircraft. Conveyor mechanism 504, in an exemplary embodiment, may be fully contained within fuselage 508, so personnel, whether manually or using cargo vehicles, need only to place payload at the opening of fuselage 508, where conveyor mechanism may then do the work required to move payload into its flight position. Additionally, or alternatively, conveyor mechanism may be only partially enclosed by fuselage 508. In this exemplary embodiment, conveyor mechanism 504 may manually or automatedly extend out past fuselage 508 such that a payload can be retracted into fuselage 508 from a distance. In yet another non-limiting example, conveyor mechanism 504 may be configurable to be either totally, partially, or not enclosed at all by fuselage 508. Pilots, personnel, or aircraft computers may command conveyor mechanism, in an embodiment, to extend out of fuselage 508, receive a payload in some way, perhaps similarly to the embodiment presented in FIGS. 4A and 4B, and retract payload into final stowage position.

Conveyor mechanism 504 may comprise a plurality of mechanisms including but not limited to conveyor belts, hooks, winches, rollers, wheels, balls, slots, channels, among others, to name a few. Referring to FIG. 5A, conveyor mechanism 504 is presented as a conveyor belt type mechanism, but this in no way limits the technologies this mechanism can take. Conveyor mechanism 504 may comprise provisions for securing payload during the translation or moving process. These provisions may be the same, similar, or different than systems disclosed in the entirety of this paper. Conveyor mechanism may be activated and further operated manually or automatedly. A pilot may control conveyor system 500 through the entirety of its operation. Activation of system may comprise the extension of conveyor mechanism 504 out of fuselage 508 after the aircraft nose is swung out of the loading path, secured to a payload, potentially using the payload pallet, and pulling the payload into the aircraft fuselage 508. Alternatively, personnel handling the loading of cargo and/or passengers into fuselage 508 through conveyor mechanism 504 may interface with electromechanical controls disposed on or in portion of eVTOL aircraft, or separately disposed but wirelessly connected to eVTOL aircraft. Conveyor system 500 does not necessarily require a powered control system, and may comprise physical interfaces like levers, ropes, pulleys, handles, among others, to name a few. These manual interfaces may allow personnel to pull a conveyor mechanism 504 out of fuselage 508 to place a payload in position in or on it.

Conveyor system 500 may comprise conveyor mechanism 504 that is completely separate from fuselage 508 and perhaps even, dual-mode aircraft. Conveyor mechanism 504 may be removed from an aircraft, operate on its own, like a cart that rolls around the exterior of an aircraft for loading on a tarmac, for example, and may then be loaded on to the forwardmost point of the fuselage and from is translated to its final stowage point within fuselage. Conveyor mechanism 504 may be configured to attach, retain, support, grasp, hold, or otherwise arrest payload, be it cargo or passengers, not necessarily designed for use in this application. Conveyor mechanism 504 may be configured to move payloads in a plurality of directions and orientations. Conveyor mechanism 504 may be bidirectional, where a payload may only move in two directions, “in” and “out” of fuselage 508. An illustrative embodiment may comprise a conveyor belt stored in the floor of fuselage 508, where a conveyor belt may then be actuated to extend out of the fuselage, a payload can be placed on and secured to conveyor belt, where then the conveyor belt pulls payload into fuselage 508 and retracts back into floor of fuselage 508. Additionally, or alternatively, conveyor mechanism 504 can move payloads in a plurality of directions. In an exemplary embodiment, rollers disposed on or in the floor of fuselage 508 may comprise spheres which extend up past floor so only a hemisphere is exposed. A payload could be rolled onto the spheres, where a combination of powered rolling spheres could move payload in any direction in a plane parallel to floor of fuselage 508. This is merely a non-limiting example, and in no way precludes other instances a conveyor mechanism 504 can take.

Conveyor mechanism 504 may be a combination of two or more machines that can retain a payload and retract or move that payload into its stowage position within fuselage 508. For example, a conveyor mechanism 504 may comprise a conveyor belt, comprising a flexible belt around two or more powered rollers, that when activated, spin, that in turn rotate conveyor belt about rollers. The rollers may be mechanically coupled to linkages that can, when actuated, change direction, length, angle, or shape of conveyor belt. In a specific embodiment, these linkages may be extended such that a payload can be pulled from a low point, diagonally upward to a higher point in fuselage 508. Additionally, linkages attached to rollers may actuate non-symmetrically to extend a conveyor diagonally in the same plane as fuselage 508 floor.

Conveyor system 500, as disclosed above, may transport payloads in three dimensions during the loading phase. Conveyor system 500 may comprise, in a non-limiting example, conveyor mechanism 504 in the form of a scissor lift, elevator, or lift. Conveyor mechanism 504 may extend out of fuselage 508 a certain length, and a second actuation could lower lift from fuselage level to loading level and bring payload to fuselage level after loading.

With continued reference to FIGS. 5A and 5B, conveyor system 500, conveyor mechanism 504, fuselage 508 may comprise suitable materials for high-strength, low-weight applications one of ordinary skill in the art of aircraft manufacture, passenger airlines, airline freighting would appreciate there is a vast plurality of materials suitable for construction of this payload system in an eVTOL aircraft. Some materials used may include aluminum and aluminum alloys, steel and steel alloys, titanium and titanium alloys, carbon fiber, fiberglass, various plastics including acrylonitrile butadiene styrene (ABS), high-density polyethylene (HDPE), and even wood, to name a few.

Sensors of plurality of sensors may be designed to measure a plurality of electrical parameters or environmental data in-flight, for instance as described above. Plurality of sensors may, as a non-limiting example, include a voltage sensor designed and configured to measure the voltage of at least an energy source. As an example, and without limitation, the plurality of sensors may include a current sensor designed and configured to measure the current of at least an energy source. As a further example and without limitation, the plurality of sensors may include a temperature sensor designed and configured to measure the temperature of at least an energy source. As another non-limiting example, the plurality of sensors may include a resistance sensor designed and configured to measure the resistance of at least an energy source. The plurality of sensors may include at least an environmental sensor. In an embodiment, environmental sensor may sense one or more environmental conditions or parameters outside the electric aircraft, inside the electric aircraft, or within or at any component thereof, including without limitation at least an energy source, at least a propulsor, or the like; environmental sensor may include, without limitation, a temperature sensor, a barometric pressure sensor, an air velocity sensor, one or more motion sensors which may include gyroscopes, accelerometers, and/or a inertial measurement unit (IMU), a magnetic sensor, humidity sensor, an oxygen sensor and/or a wind speed sensor. At least a sensor may include at least a geospatial sensor. As used herein, a geospatial sensor may include without limitation optical devices, radar devices, Lidar devices, and/or Global Positioning System (GPS) devices, and may be used to detect aircraft location, aircraft speed, aircraft altitude and/or whether the aircraft is on the correct location of the flight plan. Environmental sensor may be designed and configured to measure geospatial data to determine the location and altitude of the electronically powered aircraft by any location method including, without limitation, GPS, optical, satellite, lidar, radar. Environmental sensor may be designed and configured to measure at a least a parameter of the motor. Environmental sensor may be designed and configured to measure at a least a parameter of the propulsor. Environmental sensor may be configured to measure conditions external to the electrical aircraft such as, without limitation, humidity, altitude, barometric pressure, temperature, noise and/or vibration. Sensor datum collected in flight may be transmitted to the aircraft controller or to a remote device, which may be any device. As an example, and without limitation, remote device may be used to compare the at least an electrical parameter to the at least a current allocation threshold and/or detect that the at least an electrical parameter has reached the current allocation threshold.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

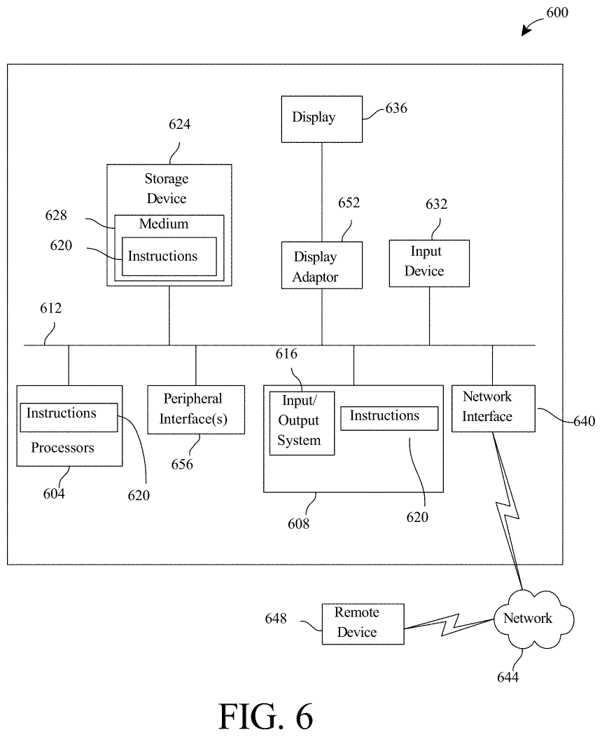

FIG. 6 shows a diagrammatic representation of one embodiment of a computing device in the exemplary form of a computer system 600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 604 and a memory 608 that communicate with each other, and with other components, via a bus 612. Bus 612 may include any of several types of bus structures including, but not limited to, a memory bus, a memory controller, a peripheral bus, a local bus, and any combinations thereof, using any of a variety of bus architectures.

Memory 608 may include various components (e.g., machine-readable media) including, but not limited to, a random-access memory component, a read only component, and any combinations thereof. In one example, a basic input/output system 616 (BIOS), including basic routines that help to transfer information between elements within computer system 600, such as during start-up, may be stored in memory 608. Memory 608 may also include (e.g., stored on one or more machine-readable media) instructions (e.g., software) 620 embodying any one or more of the aspects and/or methodologies of the present disclosure. In another example, memory 608 may further include any number of program modules including, but not limited to, an operating system, one or more application programs, other program modules, program data, and any combinations thereof.

Computer system 600 may also include a storage device 624. Examples of a storage device (e.g., storage device 624) include, but are not limited to, a hard disk drive, a magnetic disk drive, an optical disc drive in combination with an optical medium, a solid-state memory device, and any combinations thereof. Storage device 624 may be connected to bus 612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 624 (or one or more components thereof) may be removably interfaced with computer system 600 (e.g., via an external port connector (not shown)). Particularly, storage device 624 and an associated machine-readable medium 628 may provide nonvolatile and/or volatile storage of machine-readable instructions, data structures, program modules, and/or other data for computer system 600. In one example, software 620 may reside, completely or partially, within machine-readable medium 628. In another example, software 620 may reside, completely or partially, within processor 604.

Computer system 600 may also include an input device 632. In one example, a user of computer system 600 may enter commands and/or other information into computer system 600 via input device 632. Examples of an input device 632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 632 may be interfaced to bus 612 via any of a variety of interfaces (not shown) including, but not limited to, a serial interface, a parallel interface, a game port, a USB interface, a FIREWIRE interface, a direct interface to bus 612, and any combinations thereof. Input device 632 may include a touch screen interface that may be a part of or separate from display 636, discussed further below. Input device 632 may be utilized as a user selection device for selecting one or more graphical representations in a graphical interface as described above.

A user may also input commands and/or other information to computer system 600 via storage device 624 (e.g., a removable disk drive, a flash drive, etc.) and/or network interface device 640. A network interface device, such as network interface device 640, may be utilized for connecting computer system 600 to one or more of a variety of networks, such as network 644, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 620, etc.) may be communicated to and/or from computer system 600 via network interface device 640.

Computer system 600 may further include a video display adapter 652 for communicating a displayable image to a display device, such as display device 636. Examples of a display device include, but are not limited to, a liquid crystal display (LCD), a cathode ray tube (CRT), a plasma display, a light emitting diode (LED) display, and any combinations thereof. Display adapter 652 and display device 636 may be utilized in combination with processor 604 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve systems and methods as described above. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for loading and securing a payload in an electric vertical take-off and landing (eVTOL) aircraft, the system comprising:
a fuselage;
a swing nose configured to move from its flight orientation to create an opening for internal loading of aircraft and further comprising;
a hinge mechanically coupled to at least the fuselage;
a latching mechanism configured to secure a loaded payload to the fuselage;
a conveyor mechanism configured to transport a payload into the fuselage.

2. The system of claim 1, wherein the fuselage comprises structural elements further comprising at least a frame, pillar, former, stringer, intercostal, or rib.

3. The system of claim 2, wherein the structural elements comprise metals, metal alloys, wood, or composites.

4. The system of claim 1, wherein the swing nose is configured to move by rotation along a radius orthogonal to an aircraft longitudinal axis.

5. The system of claim 4, wherein the swing nose comprises composites and carbon fiber composites.

6. The system of claim 1, wherein the swing nose comprises structural elements like a frame, pillar, former, stringer, intercostal, rib.

7. The system of claim 1, wherein the hinge is mechanically coupled to at least a portion of the fuselage and at least a portion of the swing nose.

8. The system of claim 1, wherein the hinge may be actuated manually.

9. The system of claim 1, wherein the hinge may be actuated automatedly.

10. The system of claim 1, wherein the hinge may be actuated by pneumatic systems, hydraulic systems, or electronic systems.

11. The system of claim 1, wherein the latching mechanism is configured to secure a payload such that the payload does not move relative to aircraft.

12. The system of claim 11, wherein a first component of the latching mechanism is disposed on the payload and a second component is disposed on the fuselage, and wherein the first and second components are configured to mechanically couple the payload to the fuselage.

13. The system of claim 12, wherein the latching mechanism comprises a springs latch, a latch bolt, a deadlatch, a draw latch, a spring bolt lock.

14. The system of claim 12, wherein the latching mechanism is actuated manually.

15. The system of claim 12, wherein the latching system is actuated automatedly.

16. The system of claim 1, wherein the conveyor mechanism is configured to transport a payload through the opening.

17. The system of claim 15, wherein the conveyor mechanism is configured to transport a payload from an exterior of an aircraft to an interior of an aircraft.

18. The system of claim 15, wherein the conveyor mechanism comprises rollers, tracks, wheels, levers, pulleys, belts.

19. The system of claim 15, wherein the conveyor mechanism may be actuated manually.

20. The system of claim 15, wherein the conveyor mechanism is actuated automatedly.
